(19) United States
(12) Patent Application Publication
(10) Pub. No.: US 2013/0303702 A1
(43) Pub. Date: Nov. 14, 2013

(54) PROCESS FOR GRAFT POLYMERIZATION ON POLYMER SURFACES USING ORGANO-BORANE-AMINE COMPLEXES AS RADICAL INITIATORS

(71) Applicant: BASF SE, Ludwigshafen (DE)

(72) Inventors: Michael Krayer, Ludwigshafen (DE); Joachim Schmidt-Leithoff, Mannheim (DE); Kevin Neigh, Butler, PA (US); Karl Matos, Sewickly, PA (US)

(21) Appl. No.: 13/866,474

(22) Filed: Apr. 19, 2013

Related U.S. Application Data
(60) Provisional application No. 61/635,890, filed on Apr. 20, 2012.

(51) Int. Cl. C08F 291/00; C08G 73/02; C08G 77/38

(52) U.S. Cl. CPC C08F 291/00; C08G 77/38; C08G 73/0233
USPC 525/251; 525/479; 525/426

(57) ABSTRACT

The present invention relates to a process for the modification of a polymer surface. The polymer surface is treated with
(i) an organoborane-amine complex and subsequently with
(ii) a radically polymerizable monomer compound and optionally a deblocking agent.

### CROSS-REFERENCE TO RELATED APPLICATIONS

This application claims benefit (under 35 USC 119(e)) of U.S. Provisional Application 61/635,890, filed Apr. 20, 2012, which is incorporated by reference.

### BACKGROUND OF THE INVENTION

1. Field of the Invention

The present invention relates to a process for graft polymerization on polymer surfaces using organoborane-amine complexes as radical initiators.

2. Background of the Invention

Modification of polymer surfaces is often hampered by the low reactivity of the respective polymer. Numerous polymer materials are very attractive for a number of reasons including straight-forward manufacturing, low cost, and desirable physical and mechanical properties. Despite the advantages, many polymer materials have low surface energy and are non-polar, extremely hydrophobic and show only weak interfacial adhesion, which significantly impacts and diminishes their end uses.

Several methods have been developed to modify low surface energy polymers such as polydimethylsiloxane (PDMS), polyethylene (PE) or polypropylene (PP) including laser treatment (Khorasani, M. T. et al., Radiation Physics and Chemistry 1999, Vol. 55, pages 685 to 689), electron-beam radiation (Haldar, S. K. et al, Journal of Applied Polymer Science 2006, Vol. 101, pages 1340 to 1346; Anjum, N. et al., Journal of Applied Polymer Science 2008, Vol. 109, pages 1746 to 1756; Anjum, N.; Riquet, A.-M., Journal of Applied Polymer Science 2011, Vol. 119, pages 1307 to 1315; Kim, H.-J. et al., Macromolecules 2002, Vol. 35, pages 1267 to 1275), corona discharge (Yovcheva, T. A. et al., Journal of Electrostatics 2007, Vol. 65, pages 667 to 671) and oxygen plasma treatment (Karkhaneh, A. et al., Journal of Applied Polymer Science 2007, Vol. 105, pages 2208 to 2217; Liu, Y.-L. et al., Journal of Polymer Science: Part A: Polymer Chemistry 2010, Vol. 48, pages 2076 to 2083; Bodas, D.; Khan-Malek, C. Microelectronic Engineering 2006, Vol. 83, pages 1277 to 1279; Gupta, B. et al., Journal of Applied Polymer Science 2008, Vol. 107, pages 324 to 330). The most widely used method to permanently modify low surface energy polymers is oxygen plasma treatment followed by grafting of a copolymer onto the surfaces. All of these processes require harsh conditions and are labor and equipment intensive.

Treatment of polypropylene with trialkylboranes to graft ethyl acrylate, n-butyl acrylate or maleic anhydride to increase polarity of the polypropylene surface has been reported (Okamura, H. et al., Journal of Polymer Science: Part A: Polymer Chemistry 2009, Vol. 47, pages 6163 to 6167; Wang Z. M. et al., Macromolecules 2005, Vol. 38, pages 8966 to 8970) and the reaction mechanism has been studied (Sonnenschein, M. F. et al., Macromolecules 2004, Vol. 37, pages 7974 to 7978; Li, M. et al., Int. J. Adhesion & Adhesives 2011, Vol. 31, pages 36 to 42). This method requires inert conditions for the trialkylborane treatment and is not practical beyond the laboratory scale due to the pyrophoric nature of the reagent.

Polymerization of acrylic monomers with trialkylborane-amine catalysts has been investigated wherein the trialkylborane is liberated from the trialkylborane-amine complex by treatment with acrylic or acetic acid (U.S. Pat. No. 6,713,578; Sonnenschein, M. F. et al., Macromolecules 2006, Vol. 39, pages 2507 to 2513; Int. J. Adhesion & Adhesives 2008, Vol. 28, pages 126 to 134). However, this method has neither been applied for the modification of low surface energy polymers nor for grafting polymerization processes.

It was an object of the present invention to provide a process for the modification of polymer surfaces, especially low surface energy polymers, employing organoboranes as radical initiators which can be performed under an open atmosphere and, therefore, on an industrial scale.

### SUMMARY OF THE INVENTION

Accordingly, a novel process for the modification of polymer surfaces has been developed comprising treatment of a polymer surface with an organoborane-amine complex and subsequently with a radically polymerizable monomer compound and optionally a deblocking agent.

### A BRIEF DESCRIPTION OF THE DRAWINGS

FIG. 1 shows scanning electron microscope images of poly-HEMA/poly-QAEMA grafted PDMS (g=5.5%), PE (g=0.7%), and PP (g=1.6%).

FIG. 2 shows optical microscope images of (A) dry and (B) hydrated grafted poly-HEMA/poly-QAEMA PDMS (g=12.9%).

FIG. 3 shows contact angle analysis of
(A) untreated PDMS; (103°)
(B) poly-HEMA/poly-QAEMA grafted PDMS (g=2.4%), (86°);
(C) poly-HEMA/poly-QAEMA grafted PDMS (g=5.5%), (70°);
(D) poly-HEMA/poly-QAEMA grafted PDMS (g=12.9%), (instantaneous wetting).

### DETAILED DESCRIPTION OF THE INVENTION

One embodiment of the present invention is therefore a process for the modification of a polymer surface comprising treatment of a polymer surface with
(i) an organoborane-amine complex and subsequently with
(ii) a radically polymerizable monomer compound and optionally a deblocking agent.

A preferred embodiment of the present invention is a process for the modification of a low surface energy polymer comprising treatment of a low surface energy polymer with
(i) an organoborane-amine complex and subsequently with
(ii) a radically polymerizable monomer compound and optionally a deblocking agent.

According to the invention a low surface energy polymer is a polymer that shows only poor interaction with liquids and a low wettability. Low surface energy polymers are usually characterized by their contact angle, i.e. the angle at which the liquid-vapor interface of a droplet meets the solid-liquid interface. A large contact angle generally means that wetting of the surface is unfavorable so that the liquid will minimize contact with the surface and form a compact droplet. In this invention a low-energy polymer surface has a contact angle in the range of from 90° to 180°, preferably in the range of from 95° to 150°, more preferably in the range of from 95° to 135°.

Examples of polymers with low surface energy are polydimethylsiloxane (PDMS), polyethylene (PE), polypropylene (PP), polytetrafluorethylene (PTFE) and polystyrene (PS).

According to the invention the process comprises treatment of a low-energy polymer surface with an organoborane-amine complex. The organoborane-amine complex has a structure of formula (1)

R₁R₂R₃B—NR₄R₅R₆ (1),

wherein R₁, R₂ and R₃ are independently alkyl, aryl, alkoxy or aryloxy groups, with the proviso that at least one of R₁, R₂ and R₃ is an alkyl or aryl group, and

R₄, R₅ and R₆ are independently hydrogen, alkyl, cycloalkyl, substituted alkyl, alkoxy, alkylamino, aryl or heteroaryl groups, with the proviso that not more than two of R₄, R₅ and R₆ are simultaneously hydrogen, or

NR₄R₅R₆ is a heterocyclic aliphatic or aromatic amine, optionally comprising further heteroatoms selected from the group, consisting of N, O, S and P.

In a preferred embodiment of the present invention the organoborane-amine complexes are trialkylborane-amine complexes, even more preferred with R₁, R₂ and R₃ being selected from the group, consisting of methyl, ethyl, propyl, isopropyl, butyl, isobutyl and sec-butyl, most preferred with R₁, R₂ and R₃ being identical alkyl groups.

In another preferred embodiment of the present invention the amine in the organoborane-amine complexes is a primary, secondary or tertiary amine. Preferred are primary and secondary amines, even more preferred are primary amines. In another preferred embodiment of the present invention the organoborane-amine complexes comprise an amine NR₄R₅R₆, which is heterocyclic aliphatic or aromatic amine, that may contain further heteroatoms selected from the group, consisting of N, O, S and P. In another preferred embodiment of the present invention the organoborane-amine complexes comprise an amine NR₄R₅R₆, which is selected from the group, consisting of 1,2-diaminopropane, 3-methoxypropylamine, 4-dimehtylaminopyridine, 1,4-diazabicylco[2.2.2]octane, diethylenetriamine, triethylenetetraamine, propylamine, morpholine and piperidine.

As used in connection with the present invention, the term “alkyl” denotes a branched or an unbranched saturated hydrocarbon group comprising between 1 and 24 carbon atoms; examples are methyl, ethyl, propyl, isopropyl, butyl, isobutyl, sec-butyl, tert-butyl, amyl, isoamyl, sec-amyl, 1,2-dimethylpropyl, 1,1-dimethylpropyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and isopinocampheyl. Preferred are the alkyl groups methyl, ethyl, propyl, isopropyl, n-butyl, isobutyl, sec-butyl, tert-butyl, amyl, isoamyl, sec-amyl, 1,2-dimethylpropyl, 1,1-dimethylpropyl, hexyl and octyl.

The term “cycloalkyl” denotes a saturated hydrocarbon group comprising between 3 and 16 carbon atoms including a mono- or polycyclic structural moiety. Examples are cyclopropyl, cyclobutyl, cyclopentyl, cyclohexyl, cycloheptyl, cyclooctyl, cyclononyl or cyclodecyl. Preferred are cyclopropyl, cyclopentyl and cyclohexyl.

The term “aryl” denotes an unsaturated hydrocarbon group comprising between 6 and 14 carbon atoms including at least one aromatic ring system like phenyl or naphthyl or any other aromatic ring system.

The term “heteroaryl” denotes a mono- or polycyclic aromatic ring system comprising between 3 and 14 ring atoms, in which at least one of the ring carbon atoms is replaced by a heteroatom like nitrogen, oxygen or sulfur. Examples are pyridyl, pyranyl, thiopyranyl, chinolinyl, isochinolinyl, acridyl, pyridazinyl, pyrimidyl, pyrazinyl, phenazinyl, triazinyl, pyrrolyl, furanyl, thiophenyl, indolyl, isoindolyl, pyrazolyl, imidazolyl, oxazolyl, isoxazolyl, thiazolyl, isothiazolyl and triazolyl.

The term “alkoxy” denotes an -Oalkyl group derived from an aliphatic monoalcohol. The term “aryloxy” denotes an -Oaryl group derived from an aromatic monoalcohol. The term “alkylamino” denotes an alkyl group in which at least one hydrogen atom has been replaced by a —NR₄R₅ group.

The alkylborane-amine complexes can be applied neat or in solution with a solvent. Polar (e. g. THF, dioxane, alcohols) and non-polar (hydrocarbons like hexanes, pentanes, heptanes, aromatic hydrocarbons, like toluene, benzene, xylene, ethers like diethylether) solvents can be used for that purpose. Preferred are non-polar solvents. In a preferred embodiment of the present invention the alkylborane-amine complexes is applied in solution at a concentration in the range of from 0.5 to 60% (v/v), more preferred in the range of from 1 to 30% (v/v).

In a preferred embodiment of the present invention the treatment of a low surface energy polymer with an organoborane-amine complex is accomplished by submersing a piece of polymer in a solution of the organoborane-amine complex. The treatment occurs usually at a temperature of from 0 to 60° C., preferably at room temperature, for a time of from 0.1 to 60 minutes, preferably of from 1 to 10 minutes.

At the end of the treatment the piece of polymer is removed from the solution of the organoborane-amine complex and afterwards treated with a radically polymerizable monomer compound and optionally a deblocking agent. Again, this treatment is preferably accomplished by submersing the piece of polymer in a solution comprising at least one radically polymerizable monomer compound and optionally at least one deblocking agent. Alternatively, the piece of polymer is submersed in a solution comprising only the at least one radically polymerizable monomer compound and the at least one deblocking agent is optionally added neat or in solution. No deblocking agent is needed when the monomer itself acts as a deblocking agent (e. g. in the case of acrylic acid) or deblocking can be achieved thermally.

According to the invention a radically polymerizable monomer compound is a monomer that is able to undergo a radical polymerization reaction. These are generally unsaturated compounds with a structure of formula (2) comprising an olefinic double bond

R₇R₈C═CR₉R₁₀ (2),

or with a structure of formula (3) comprising an acetylenic triple bond

R₇C≡CR₈ (3),

or with a structure of formula (4) comprising a carbonyl group

R₇R₈C═O (4),

or with a structure of formula (5) comprising a carbon nitrogen double bond

R₇R₈C═NR₉ (5),

wherein R₇, R₈, R₉ and R₁₀ are independently for example hydrogen, alkyl, cycloalkyl, substituted alkyl, aralkyl, alkaryl, alkoxy, aryloxy, alkylamino, aryl or heteroaryl, carbonyl, carboxyl, amide, ester or nitrile groups.

The term “substituted alkyl” denotes an alkyl group in which at least one hydrogen atom is replaced by a halide atom like fluorine, chlorine, bromine or iodine or by a heteroatom, e. g. boron, silicon, nitrogen, phosphorus, oxygen, sulphur or by a protected or unprotected functional group like alkoxy, amino, ammonium, ester, amide, nitrile, carbonyl, carboxyl etc.

The term “aralkyl” denotes an aryl-substituted alkyl group including for example benzyl, 1- or 2-phenylethyl, 1-, 2- or 3-phenylpropyl, mesityl and 2-, 3- or 4-methylbenzyl groups.

The term “alkaryl” denotes an alkyl-substituted aryl group including for example 2,- 3- or 4-methylphenyl, 2,- 3- or 4-ethylphenyl and 2,- 3-, 4-, 5-, 6-, 7- or 8-methyl-1-naphthyl groups.

Preferred radically polymerizable monomers are ethylene, propylene, butadiene, isoprene, vinyl chloride, vinyl fluoride, styrene, acrylic and methacrylic acid, acrylic and methacrylic acid esters, acrylonitrile, vinyl acetate, 2-hydroxyethylmethacrylate (HEMA), [2-(methacryloyloxy)ethyl] trimethylammonium chloride (QAEMA), glycidyl methacrylate (GMA), diallyldimethylammonium chloride (DADMA), 1-vinyl-2-pyrrolidinone (NVP) and N-dodecyl(2-(methacryloyloxy)ethyl)-N,N-dimethylammonium bromide (QAEMA-C12) or mixtures thereof.

In one embodiment of the present invention the radically polymerizable monomer compound is applied in solution. Suitable solvents are e. g. water, alcohols, THF for polar monomers and hydrocarbons like pentanes, hexanes, heptanes, toluene and benzene or ethers like diethylether and methyl-tert.-butylether for nonpolar monomers. In a preferred embodiment of the present invention the radically polymerizable monomer compound is applied in solution at a concentration in the range of from 1 to 75% (v/v), more preferred in the range of from 2 to 50% (v/v).

In another embodiment of the present invention the radically polymerizable monomer compound is applied as a neat liquid.

According to the invention a deblocking agent has optionally to be employed. A deblocking agent is a compound that is able to split an organoborane-amine complex to liberate the organoborane. Suitable deblocking agents are for example Lewis acids like aluminium trichloride and trifluoroborane, Broensted acids like mineral acids or organic acids, e.g. acrylic acid, methacrylic acid, acetic acid or citric acid, carbon dioxide, aldehydes, ketones, etc. Preferred deblocking agents are acrylic acid and methacrylic acid.

In another embodiment of the present invention an organoborane-amine complex is employed that will sufficiently dissociate at higher temperatures to initiate radical polymerization so that the liberation of the organoborane can be achieved by simple heating of the reaction mixture. In such cases a further deblocking agent is obsolete.

Treatment with at least one radically polymerizable monomer compound and optionally at least one deblocking agent is usually carried out at a temperature of from 0 to 80° C., preferably at room temperature, during a time of from 1 to 100 minutes, preferably of from 10 to 60 minutes.

After the treatments according to the invention any excess polymerized material that is not grafted onto the surface of the piece of polymer can be removed, e.g. by scrubbing the surface with a clean brush under running water or by dissolving any excess polymerized material in a suitable solvent.

Another embodiment of the present invention is therefore a process for the modification of a polymer surface comprising treatment of a polymer surface with
(i) an organoborane-amine complex and subsequently with
(ii) a radically polymerizable monomer compound and optionally a deblocking agent, and
(iii) removal of any excess polymerized material that is not grafted onto the surface.

Another preferred embodiment of the present invention is therefore a process for the modification of a low surface energy polymer comprising treatment of a low surface energy polymer with
(i) an organoborane-amine complex and subsequently with
(ii) a radically polymerizable monomer compound and optionally a deblocking agent, and
(iii) removal of any excess polymerized material that is not grafted onto the surface.

### DESCRIPTION OF THE DRAWINGS

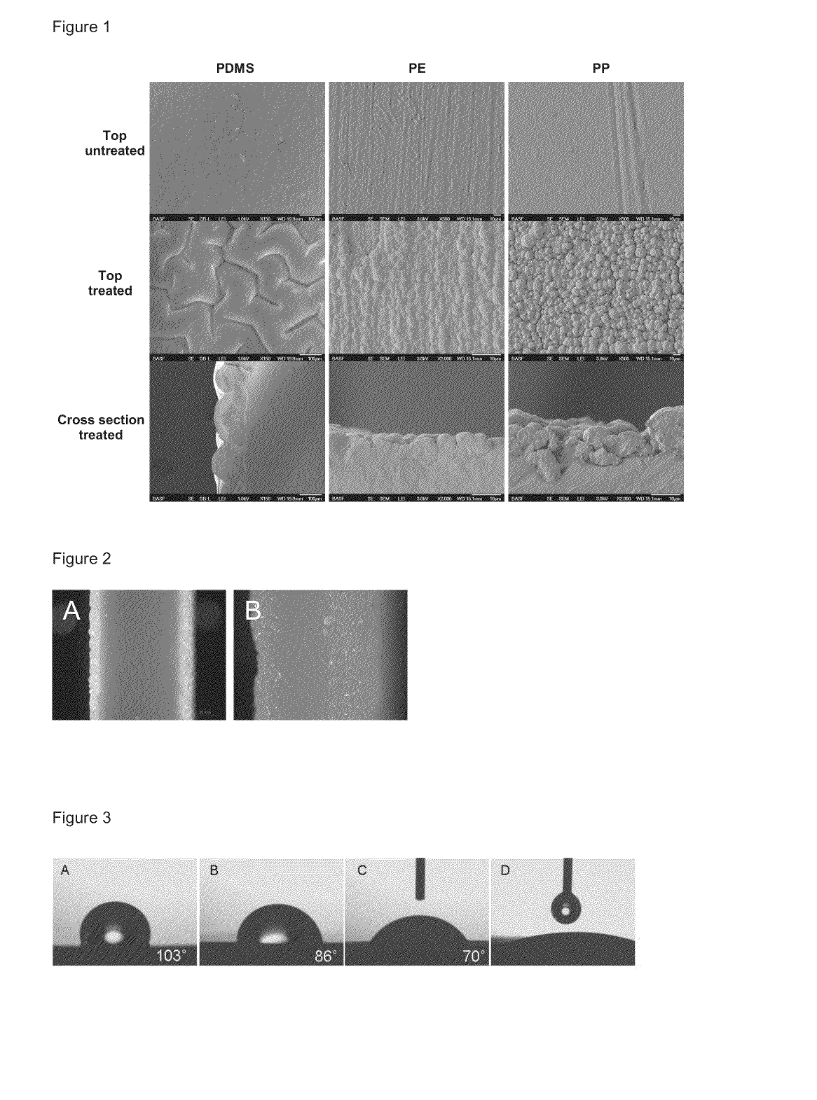

FIG. 1 shows scanning electron microscope images of poly-HEMA/poly-QAEMA grafted PDMS (g=5.5%), PE (g=0.7%), and PP (g=1.6%).

FIG. 2 shows optical microscope images of (A) dry and (B) hydrated grafted poly-HEMA/poly-QAEMA PDMS (g=12.9%).

FIG. 3 shows contact angle analysis of
(A) untreated PDMS; (103°)
(B) poly-HEMA/poly-QAEMA grafted PDMS (g=2.4%), (86°);
(C) poly-HEMA/poly-QAEMA grafted PDMS (g=5.5%), (70°);
(D) poly-HEMA/poly-QAEMA grafted PDMS (g=12.9%), (instantaneous wetting).

### EXAMPLES

Medical grade polydimethylsiloxane (PDMS) sheet (2.4 mm thick) was purchased from the CS Hyde Company. High-density polyethylene (PE) (3.2 mm thick), isotactic polypropylene (PP) (3.2 mm thick) Nylon 6 (6.4 mm thick) were purchased from McMaster-Carr. Polytetrafluoroethylene (PTFE) (3.2 mm thick) was purchased from Small Parts.

Typical procedure for the preparation of surface-grafted polymer: A preweighted 10 cm×10 cm polymer sheet was submerged in a solution of either

tri-sec-butylborane-diaminopropane (TsBB.DAP),

tri-n-butylborane-morpholine (TnBB.M),

tri-n-butylborane-methoxypropylamine (TnBB.MOPA) or

triethylborane-diaminopropane (TEB.DAP)

in pentane or THF (10% v/v) for 1 or 5 min. The polymer sheet was then removed from the solution and immediately treated with an aqueous monomer solution (40% v/v) of 2-hydroxyethylmethacrylate (HEMA), [2-(methacryloyloxy)ethyl]trimethylammonium chloride (QAEMA) and acrylic acid (AAc) (1:1:0.1) for 15, 30 or 60 min. The polymer sheet was then removed from the mixture and excess grafted polymer was removed by scrubbing with a clean brush under running water. The samples were then dried overnight in a vacuum desiccator and the weight (w_{g}) of the treated polymer sheet was recorded. From the weight increase and the original weight of the polymer sheet (w₀) the corresponding grafting ratio (g) was calculated as

g=w_{g}−w₀/w₀×100

as well as the amount of grafted polymer as (w_{g}−w₀)/surface area (mg/cm²).

The samples where further analyzed by calculating a swelling ratio (s) as

s=w_{g}(hydrated)−w_{g}(dry)/w_{g}(hydrated)×100,

contact angle analysis, scanning electron microscopy (SEM), optical microscopy and attenuated total reflectance IR spectroscopy (ATR-FTIR).

Results are shown in Table 1. It is evident that the amount of grafting onto a given polymer can be controlled by a number of variables including (i) the nature of the organoborane-amine complex, (ii) treatment time with the organoborane-amine complex, (iii) concentration of the organoborane-amine complex solution (iv) solvent for the organoborane-amine complex solution, (v) treatment time with the monomer, and (vi) concentration of the monomer solution.

PDMS showed the greatest amount of grafting (2.4%-12.9%, 3.3-17.9 mg/cm²) compared to PE, PP or PTFE (0.1%-1.6%, 0.1-2.1 mg/cm²). The degree of surface grafting on the selected polymer can be readily controlled by changing the treatment times with the organoborane-amine complex and/or the monomer solution. The higher grafting ratios for PDMS, compared to the other polymers, can be explained by the greater swelling of PDMS in the pentane solution, which consequently results in a greater amount of organoborane-amine complex absorbed by the PDMS.

Further, the grafting ratio could be controlled by changing the organoborane-amine complex. Grafting onto PDMS using tri-n-butylborane-morpholine (TnBB.M) or tri-n-butylborane-methoxypropylamine (TnBB.MOPA) resulted in increased amounts of grafted polymer (4.1-17.8%, 5.5-25.9 mg/cm²) compared to TsBB.DAP. The triethylborane-diaminopropane (TEB.DAP) complex was not soluble in pentanes and therefore was used as a THF solution instead. The grafting ratio when using TEB.DAP in THF were significantly lower (0.5-2.9%, 0.8-4.2 mg/cm²) compared to the other alkylborane complexes in pentane. The lower grafting ratio can be a result of the THF being more polar than pentane and therefore having less of a swelling effect on PDMS. Further, TEB.DAP is more polar than the other alkylborane amine complexes and may not penetrate into the polymer surface as well.

TABLE 1
Grafting of different substrates with HEMA/QAEMA/AAc.^{a}

| | | | | Results | | |
|---|---|---|---|---|---|---|
| | Borane-amine | Treatment time (min) | | Grafting | grafted | |
| Polymer | complex | BR₃-L | aq. | ratio^{c} | polymer | Thickness |
| Substrate | BR₃-L | solution^{b} | monomer | g [%] | (mg)/cm² | (μm)^{d} |
| PDMS | TsBB•DAP | 1 | 15 | 2.4 | 3.3 | ~30 |
| | | 1 | 30 | 5.5 | 7.6 | 100-160 |
| | | 1^{e} | 30 | 10.5 | 16.2 | |
| | | 1 | 30^{f} | 3.7 | 5.4 | |
| | | 1 | 60 | 12.9 | 17.9 | 160-200 |
| | TnBB•M | 1 | 15 | 5.3 | 7.7 | |
| | | 1 | 30 | 9.8 | 13.9 | |
| | | 1 | 60 | 17.8 | 25.9 | |
| | TnBB•MOPA | 1 | 15 | 4.1 | 5.5 | |
| | | 1 | 30 | 9.3 | 12.9 | |
| | | 1 | 60 | 17.2 | 23.2 | |
| | TEB•DAB | 1^{g} | 15 | 0.5 | 0.8 | |
| | | 1^{g} | 30 | 1.2 | 1.8 | |
| | | 1^{g} | 60 | 2.9 | 4.2 | |
| PE | TsBB•DAP | 1 | 15 | 0.1 | 0.1 | |
| | | 1 | 30 | 0.2 | 0.2 | |
| | | 1 | 60 | 0.4 | 0.6 | |
| | | 5 | 15 | 0.2 | 0.2 | |
| | | 5 | 30 | 0.4 | 0.6 | |
| | | 5 | 60 | 0.7 | 1.0 | 6-12 |
| PP | | 5 | 15 | 0.3 | 0.4 | |
| | | 5 | 30 | 0.7 | 0.9 | |
| | | 5 | 60 | 1.6 | 2.1 | 8-17 |
| PTFE | | 5 | 15 | 0.1 | 0.1 | |
| | | 5 | 30 | 0.2 | 0.4 | |
| | | 5 | 60 | 0.4 | 1.1 | |
| Nylon 6 | | 5 | 15 | 0.1 | 0.2 | |
| | | 5 | 30 | 0.2 | 0.6 | |
| | | 5 | 60 | 0.3 | 0.9 | |

^{a}HEMA, QAEMA, AAc (1:1:0.1) 40% (v/v) in H₂O unless noted otherwise;
^{b}10% in pentane unless noted otherwise;
^{c}g = w_{g} − w₀/w₀ × 100;
^{d}determined by SEM;
^{e}20% in pentanes;
^{f}HEMA, QAEMA, AAc (1:1:0.1) 10% (v/v) in H₂O;
^{g}10% in THF.

Further, the grafting ratio could be controlled by changing the concentration of the organoborane-amine complex solution or of the monomer solution. For example, treatment of PDMS with a 20% solution of TsBB.DAP (instead of 10%) in pentane (1 min), followed by treatment with the 40% aqueous solution of HEMA/QAEMA (30 min) resulted in an increased grafting ratio of 10.5%. Alternatively, treatment of PDMS with a 10% solution of TsBB.DAP in pentane (1 min), followed by treatment with a 10% aqueous solution of HEMA/QAEMA (instead of 40%) (30 min) resulted in a decreased grafting ratio of 3.7%.

Surface grafting on PDMS was also performed using different monomers (either DADMA, DADMA/HEMA, GMA, or NVP/QAEMA-C12). The corresponding grafting ratios/amounts are listed in Table 2. DADMA without the addition of HEMA showed significantly less grafting than the combination of DADMA/HEMA. The GMA monomer is not miscible with water and was therefore used as a neat liquid rather than an aqueous solution. ATR-FTIR of the poly-GMA grafted PDMS showed the characteristic absorption bands for carbonyl (1725 cm⁻¹) and epoxy (906 cm⁻¹). However, further modification of the poly-GMA grafted PDMS with di-n-propylamine was unsuccessful due to the swelling of PDMS in dialkylamines.

TABLE 2

| | | | | Results | |
|---|---|---|---|---|---|
| Polymer | | Treatment time (min) | | Grafting | grafted |
| sub- | | TsBB·DAP | aq. | ratio^{d} | polymer |
| strate | Monomers | solution^{b} | monomer | g [%] | (mg)/cm² |
| PDMS | NVP/QAEMA- | 1 | 30 | 7.8 | 10.5 |
| | C12 (4:1) | | | | |
| | DADMA, AAc | 1 | 30 | 2.3 | 3.2 |
| | (1:1/20) 40% | | | | |
| | (v/v) in H₂O | | | | |
| | DADMA, | 1 | 30 | 12.4 | 17.6 |
| | HEMA, AAc | | | | |
| | (1:1:0.1) 40% | | | | |
| | (v/v) in H₂O | | | | |
| | GMA, AAc | 1 | 30 | 4.0 | 5.7 |
| | (1:1/20) | | | | |

To confirm that the grafted polymer is permanently bound to the surface of the bulk polymer, a piece of grafted polypropylene was washed with CHCl₃ for 2 hours and the mother liquor was analyzed by GC analysis, showing no additional peak beside the one for CHCl₃.

Selected samples were further analyzed by ATR-FTIR, SEM microscopy and water surface contact angle measurements. ATR-FTIR measurements of grafted PDMS clearly showed the appearance of an O—H stretch (3350 cm⁻¹) indicating the presence poly-HEMA, a C═O peak (1725 cm⁻¹) which results from both poly-HEMA and poly-QAEMA, and C—N—C antisymmetrical stretches (1450-1500 cm⁻¹) indicating the presence poly-QAEMA. Quantitative ATR-FTIR analysis from the absorbance of the O—H stretch versus the C—N—C antisymmetrical stretches showed that the ratio of the two species was constant for samples treated for 15, 30 and 60 minutes.

SEM images of PDMS, PP, and PE grafted with poly-HEMA/poly-QAEMA are shown in FIG. 1. Top down views show the surface morphology, and the cross sectional view gives information about the thickness of the grafted polymer. For PDMS the thickness of the grafted polymer was 30·m, 100-160·m and 160-200·m for samples treated 15, 30 and 60 minutes with aqueous monomer, respectively. For PE and PP the thickness of the grafted polymer, after a 5 minute treatment with an alkylborane-amine complex and a 60 minute treatment with an aqueous monomer solution, was 6 to 12·m and 8 to 17·m, respectively (Table 1). The thicknesses of the grafted polymer layers determined by SEM are consistent with the calculated amount of grafted polymer and the grafting ratio g.

The grafted polymer poly-HEMA/poly-QAEMA tends to become stiff and inflexible after drying. However when treated with water the grafted poly-HEMA/poly-QAEMA layer hydrates, swells and becomes flexible again. Optical microscopy of the grafted PDMS samples shows the swelling/hydration of the grafted poly-HEMA/poly-QAEMA (FIG. 2).

To determine the hydrophilicily of the grafted poly-HEMA/poly-QAEMA on PDMS, the water contact angles were determined on both the dry and the hydrated samples. The dry surfaces of grafted PDMS samples exhibit minute variations in the contact angle compared to the untreated sample)(102-103°), however, the hydrophilicity seem to increase as a function of time. The rate of water absorption to the grafted poly-HEMA/poly-QAEMA was not exactly determined, because of changes in the droplet volume in the ambient environment test conditions. However, the fully hydrated samples showed a significant increase in hydrophilicity. The respective contact angles for the untreated PDMS sample, and PDMS samples treated for 15 and 30 minutes, were 103°, 86° and 70°. The hydrated PDMS sample, which was treated for 60 minutes showed instantaneous wetting (FIG. 3).

It is known that surfaces with quaternary amines show antibacterial activity. Accordingly, the poly-HEMA/poly-QAEMA grafted PDMS with an average grafting ration of 5.5%, 7.6 mg/cm² showed a 1.8 and 2 log units of reduction in a standard test against E. coli and S. aureous, respectively (according to the method disclosed in Japanese Industrial Standard JIS Z 2801:2000) (Table 3).

TABLE 3
Antimicrobial activity of grafted PDMS^{a}

| Polymer substrate | bacterium | bacteria killed | log reduction |
|---|---|---|---|
| poly-HEMA/poly-QAEMA | E. coli | 98.4% | 1.8 |
| grafted PDMS (g = 5.5%) | S. aureous | 99.2% | 2.0 |

^{a}Test method: JIS Z 2801: 2000

1-13. (canceled)

14. A process for the modification of a polymer surface comprising treating a polymer surface with
(i) an organoborane-amine complex and subsequently with
(ii) a radically polymerizable monomer compound and optionally a deblocking agent.

15. The process according to claim 14, wherein any excess polymerized material that is not grafted onto the surface is removed.

16. The process according to claim 14, wherein the polymer has a low surface energy.

17. The process according to claim 14, wherein the organoborane-amine complex has a structure of formula (1)
R₁R₂R₃B—NR₄R₅R₆ (1),
wherein R₁, R₂ and R₃ are independently alkyl, aryl, alkoxy or aryloxy groups, with the proviso that at least one of R₁, R₂ and R₃ is an alkyl or aryl group, and
R₄, R₅ and R₆ are independently hydrogen, alkyl, cycloalkyl, substituted alkyl, alkoxy, alkylamino, aryl or heteroaryl groups, with the proviso that not more than two of R₄, R₅ and R₆ are simultaneously hydrogen, or
NR₄R₅R₆ is a heterocyclic aliphatic or aromatic amine, optionally comprising further heteroatoms selected from the group, consisting of N, O, S and P.

18. The process according to claim 17, wherein the organoborane-amine complex is a trialkylborane-amine complex.

19. The process according to claim 14, wherein the radically polymerizable monomer compound has a structure of formula (2) comprising an olefinic double bond
R₇R₈C═CR₉R₁₀ (2),
or with a structure of formula (3) comprising an acetylenic triple bond
R₇C≡CR₈ (3),
or with a structure of formula (4) comprising a carbonyl group
R₇R₈C═O (4),
or with a structure of formula (5) comprising a carbon nitrogen double bond
R₇R₈C═NR₉ (5),
wherein R₇, R₈, R₉ and R₁₀ are independently for example hydrogen, alkyl, cycloalkyl, substituted alkyl, aralkyl, alkaryl, alkoxy, alkylamino, aryl or heteroaryl, carbonyl, carboxyl, amide, ester or nitrile groups.

20. The process according to claim 14, wherein the radically polymerizable monomer compound is ethylene, propylene, butadiene, isoprene, vinyl chloride, vinyl fluoride, styrene, acrylic acid, methacrylic acid, an acrylic or methacrylic acid ester, acrylonitrile, vinyl acetate, 2-hydroxyethylmethacrylate (HEMA), [2-(methacryloyloxy)ethyl]trimethylammonium chloride (QAEMA), glycidyl methacrylate (GMA), diallyldimethylammonium chloride (DADMA), 1-vinyl-2-pyrrolidinone (NVP) or N-dodecyl(2-(methacryloyloxy)ethyl)-N,N-dimethylammonium bromide (QAEMA-C12) or mixtures thereof.

21. The process according to claim 14, wherein the deblocking agent is a mineral or an organic acid.

22. The process according to claim 16, wherein the low surface energy polymer has a contact angle or from 90° to 180°.

23. The process according to claim 16, wherein the low surface energy polymer is polydimethylsiloxane (PDMS), polyethylene (PE), polypropylene (PP), polytetrafluorethylene (PTFE) or polystyrene (PS).

24. The process according to claim 14, wherein the organoborane-amine complex is applied in solution at a concentration in the range of from 0.5 to 60% (v/v).

25. The process according to claim 14, wherein the radically polymerizable monomer compound is applied in solution at a concentration in the range of from 1 to 75% (v/v).

26. The process according to claim 25, wherein the solution comprises water.
